(19) United States
(12) Patent Application Publication
(10) Pub. No.: US 2016/0184944 A1
(43) Pub. Date: Jun. 30, 2016

(54) MACHINING SYSTEM WITH TOOL CONVEYANCE DEVICE

(71) Applicant: FANUC Corporation, Yamanashi (JP)

(72) Inventor: Gaku ISOBE, Yamanashi (JP)

(21) Appl. No.: 14/978,558

(22) Filed: Dec. 22, 2015

(30) Foreign Application Priority Data
Dec. 24, 2014 (JP) 2014-260570

(51) Int. Cl. B23Q 3/157; B23Q 17/09

(52) U.S. Cl. CPC B23Q 3/15713; B23Q 17/0995

(57) ABSTRACT

A tool conveyance device configured to mount and dismount a tool on a tool magazine includes at least one of an information read deice for reading tool information and an information write device for writing tool information in an information medium provided in the tool. The machining system having the tool conveyance device includes a communication unit configured to send and receive the tool information among a control device of the machining tool, the tool conveyance device, and the information read device or the information write device.

### BACKGROUND OF THE INVENTION

1. Field of the Invention

The present invention relates to a machining system with a machining tool and a tool conveyance device for conveying a tool to a tool magazine or a spindle of the machining tool, and more specifically to a machining system with a tool conveyance device having function of communicating with machining tool and reading and writing tool information in an information medium of the tool.

2. Description of the Related Art

The present invention relates to a machining system with a machining tool and a tool conveyance device for conveying a tool to a tool magazine or a spindle of the machining tool, and more specifically to a machining system with a tool conveyance device having function of communicating with a machining tool and reading and writing tool information in an information medium of the tool.

A machining system having a tool conveyance device which conveys a tool to a tool magazine or a spindle of the machining tool from the outside of the machining tool or conveys the tool from the tool magazine or the spindle to the outside of the machining tool, and exchanges the tool is known. The machining system enables automatic machining without being regulated by a maximum number of storable tools of the machining tool.

A machining tool, whose control device stores tool information such as tool length, tool diameter, and tool weight of the tool on the tool magazine, which determines offset amount of each axis at machining or changes operation speed of the tool magazine using the information is generally known.

However, when a tool is conveyed from the outside of the machining tool to the tool magazine as described above, input of the tool information to the control device of the machining tool is required.

A machining tool enabling automatic input of the tool information by providing a measurement device for inputting the tool information such as tool length and tool diameter the conveyed tool in the machining tool is known.

In addition to that, an automatic management system of the tool information, in which the tool is provided with an information medium such as a bar code or an IC tag, instead of the measurement device in the machining tool, and a read device installed in the machining tool reads the information medium to automatically input the tool information stored in the information medium in a control device of the machining tool is known.

However, there has been a case where installing of the measurement device or the read device in the machining tool is difficult considering space in the machining tool or the surrounding environment such as influence of chips and cutting fluid.

In Japanese Patent Laid-Open No. 04-331036, a tool management system enabling automatic checking of a tool designated in machining program and a tool set in a tool magazine, using an identifier and a read/write device thereof, is disclosed.

In Japanese Patent Laid-Open No. 2007-098561, a tool storing device, including a read device of a tool information medium attached to a tool for enabling simple tool management, is disclosed.

However, since a read/write head of the tool data is installed in the machining tool in Japanese Patent Laid-Open No. 04-331036, there is a problem that the system can not be implemented when the space or the environment makes it difficult to install the read/write head in the machining tool, as described above.

In addition to that, the Japanese Patent Laid-Open No. 04-331036 assumes manual attachment of the tool to the tool magazine. Even when the manual attachment is replaced by automatic attachment using a conveyance device, since attachment operation and reading operation of the tool information are divided to each other, there is a problem that long cycle time is required.

In Japanese Patent Laid-Open No. 2007-098561, storing and searching of the tool information in the tool storing device are enabled, but the tool storing device does not have function of communicating with the machining tool and sending and receiving the tool information.

Therefore, automatic input of the tool information in the machining tool has not been implemented.

### SUMMARY OF THE INVENTION

In view of the above-described problems in the prior art techniques, in a machining system having a machining tool and a tool conveyance device for conveying a tool to a tool magazine or a spindle of the machining tool of the present invention, the tool conveyance device includes an information read/write deice for reading/writing tool information in an information medium and the machining system includes a communication unit to send and receive the tool information between a control device of the machining tool.

A machining system having a tool conveyance device of the present invention includes a machining tool equipped with a spindle and a tool magazine, a tool conveyance device configured to mount and dismount the tool on the tool magazine, a tool stand for placing the tool to be mounted on the tool magazine or dismounted from the tool magazine, wherein, the tool conveyance device includes at least one of an information read deice for reading tool information and an information write device for writing tool information in an information medium provided in the tool, and the machining system having the tool conveyance device comprises a communication unit configured to send and receive the tool information among a control device of the machining tool, the tool conveyance device, and the information read device or the information write device.

With the above configuration, when the tool conveyance device conveys and attaches the tool to the tool magazine of the machining tool, automatic input of the tool information of the tool to be conveyed to the control device,of the machining tool to the control device or the like is enabled.

In addition to that, when the tool is detached from the tool magazine of the machining tool and conveyed, automatic updating of the tool information stored in the information medium of the tool is enabled by receiving the update data of the tool information from the control device of the machining tool and writing the update data in the information medium of the tool.

Furthermore, reduction of the cycle time is enabled by simultaneously performing conveyance operation of the tool and reading or writing of the data, compared to performing the conveyance operation and the reading or the writing separately.

A machining system having a tool conveyance device according to the present invention includes a machining tool equipped with a spindle configured to be removably attached by a tool, a tool conveyance device configured to mount and dismount the tool on the spindle, a tool stand for placing the tool to be mounted on the spindle or dismounted from the spindle, wherein the tool conveyance device includes at least one of an information read deice for reading tool information and an information write device for writing tool information in an information medium provided in the tool, and the machining system having the tool conveyance device comprises a communication unit configured to send and receive the tool information among a control device of the machining tool, the tool conveyance device, and the information read device or the information write device.

With the above configuration, when the tool conveyance device conveys and attaches the spindle to the tool the machining tool, automatic input of the tool information of the tool to be conveyed to the control device of the machining tool to the control device or the like is enabled.

In addition to that, when the tool is detached from the spindle of the machining tool and conveyed, automatic updating of the tool information stored in the information medium of the tool is enabled by receiving the update data of the tool information from the control device of the machining tool and writing the update data in the information medium of the tool.

Furthermore, reduction of the cycle time is enabled by simultaneously performing conveyance operation of the tool and reading or writing of the data, compared to performing the conveyance operation and the reading or the writing separately.

The tool information may include at least one of, tool number, tool length, tool length correction value, tool diameter, tool diameter correction value, tool weight, gravity center position of the tool, tool lifetime, tool use frequency, and tool use time.

With the above configuration, determination of the machining operation based on appropriate tool information when the machining tool performs machining using the tool is enabled, by sending the tool information to the control device of the machining tool when the tool is attached to the tool magazine or the spindle of the machining tool by the tool conveyance device.

The machining tool may include a display unit configured to display message or alarm when the tool use time exceeds the tool lifetime.

With the above configuration, display of message or alarm when an operator tries to use the tool beyond the lifetime of the tool enables to prevent occurrence of damage of the tool or deterioration of machining precision.

The tool conveyance device may include a unit for conveying the tool to outside of the machining system and convey and supply a tool other than the conveyed tool from the outside of the machining system to the tool stand when the tool use time exceeds the tool lifetime.

With the above configuration, operation of the machining system with high efficiency is enabled, since there is no need for stopping operation of the machining system when the lifetime of the tool ends.

The present invention, with the above configuration, enables reading and writing of the tool information and sending and writing of the tool information to the control device of the machining tool before, during, or after the conveyance operation of the tool by the tool conveyance device such as a handling robot to the machining tool.

With the configuration, automatic input of the tool information of the tool to be conveyed to the control device of the machining tool when the tool is conveyed from the outside to the machining tool.

In addition to that, automatic updating of the tool information is enabled by receiving the update data of the tool information from the control device of the machining tool and writing the update data in the information medium of the tool, when the tool is detached from the tool magazine of the machining tool and conveyed.

Furthermore, the cycle time can be reduced since reading / writing of the tool information during conveyance of the tool is enabled, compared to a case where the conveyance operation and the reading or the writing operation are separately performed.

### BRIEF DESCRIPTION OF THE DRAWINGS

The above-described object, the other object, and the feature of the invention will be proved from the description of embodiments below with reference to the accompanying drawings. In these drawings:

FIG. 1 is a diagram illustrating a machining tool having a tool magazine.

FIG. 2 is a schematic diagram illustrating a tool having an information medium.

FIG. 3 is a schematic diagram illustrating a machining system comprising a machining tool, a tool conveyance device, and a tool stand.

FIG. 4 is a diagram illustrating initial operation when a tool is attached to a tool magazine.

FIG. 5 is a schematic diagram illustrating operation when a tool is attached to a tool magazine.

FIG. 6 is a block diagram illustrating control for attaching a tool.

FIG. 7 is a diagram illustrating initial operation when a tool is detached from a tool magazine.

FIG. 8 is a schematic diagram illustrating operation when a tool is detached from a tool magazine.

FIG. 9 is a block diagram illustrating control for detaching a tool.

FIG. 10 is a block diagram illustrating sending and receiving of tool information between a control device of a machining tool and an information medium of a tool.

### DETAILED DESCRIPTION OF THE PREFERRED EMBODIMENTS

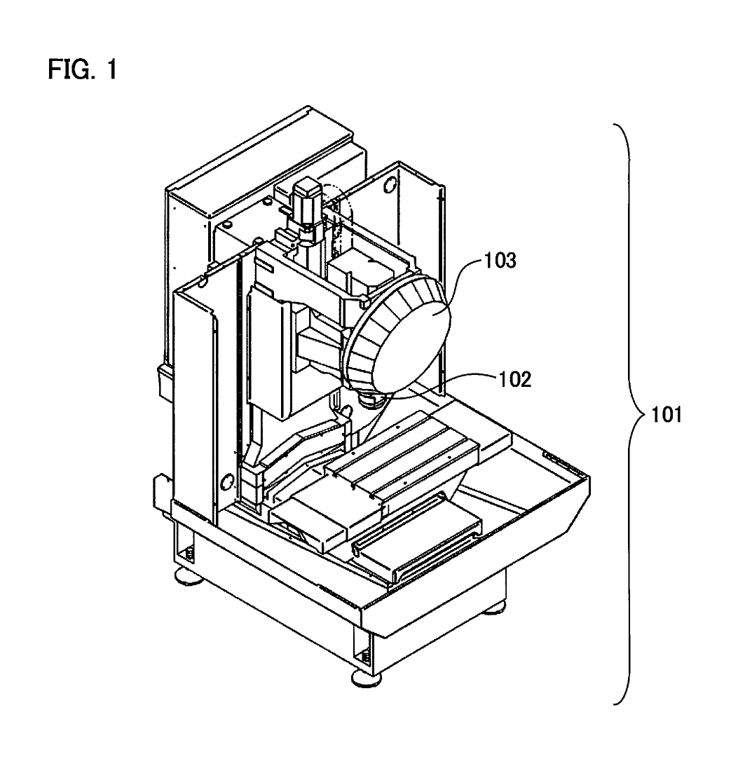

FIG. 1 is a diagram illustrating an example of a machining tool having a tool magazine. The tool magazine includes a spindle to which a tool is configured to be removably attached, and a tool magazine equipped with plural tool holding units. When the tool is exchanged, the tool magazine is controlled to index the tool holding unit which holds the tool to be attached to the spindle position and exchanges the tool.

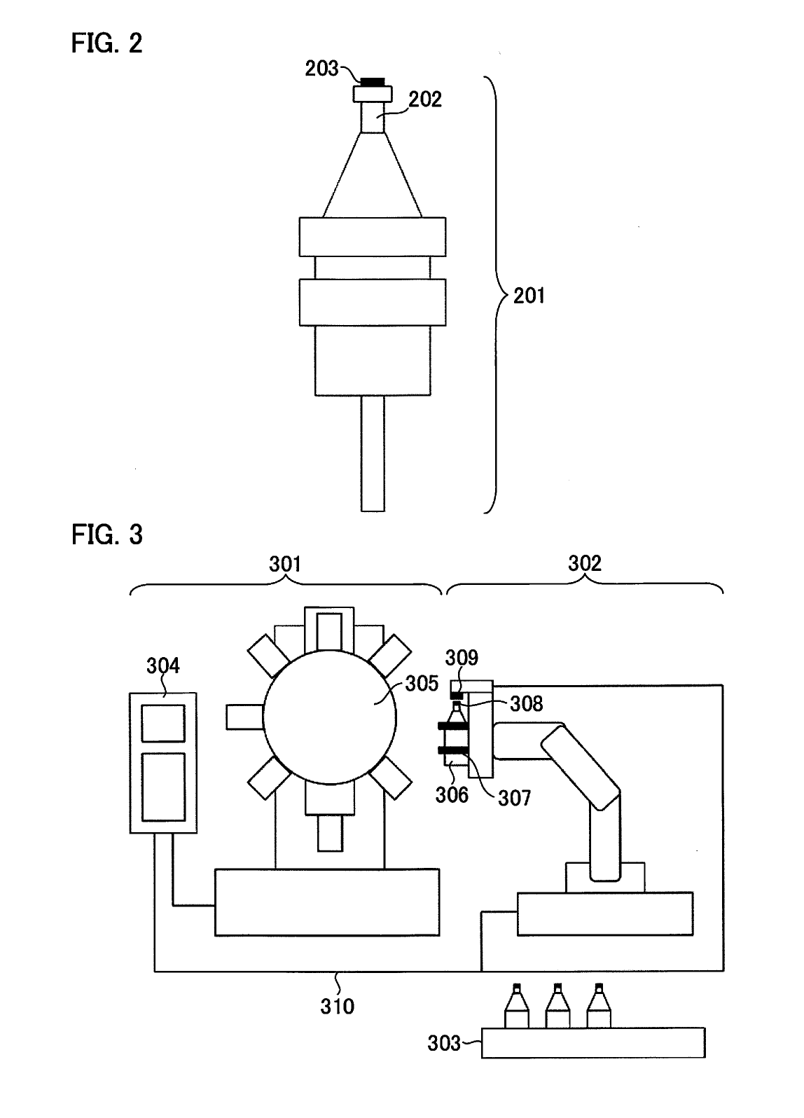

FIG. 2 is a diagram illustrating an example of the tool to be used in the machining tool. An information medium using a magnetic memory element is attached to a pull stud unit of the tool. Tool information, such as tool number, tool length, tool length correction value, tool diameter, tool diameter correction value, tool weight, gravity center position of the tool, tool lifetime, tool use frequency, and tool use time, is stored in the information medium.

FIG. 3 is a diagram illustrating the machining system comprising the machining tool, the handling robot set outside the machining tool, and the tool stand set outside the machining tool.

The handling robot is capable of performing operation of detaching the tool from the tool holding unit located at tool detachment and attachment position of the tool magazine of the machining tool to convey the tool to the tool stand, and performing operation of attaching the tool to the tool holding unit located at the tool detachment and attachment position of the tool magazine.

In a hand unit of the handling robot, an information reading and writing device equipped with a magnetic head, which is capable of reading and writing of information to the magnetic memory element, is provided, such that the hand unit is capable of reading and writing information to the information medium of the tool.

The information reading and writing device, the handling robot, and the control device of the machining tool are connected through a data cable capable of sending and receiving information.

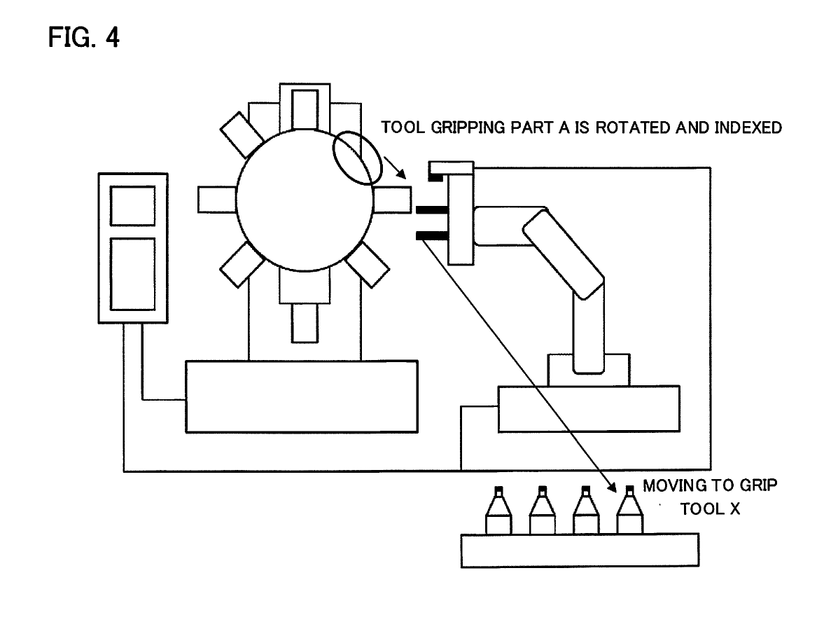

FIG. 4 is a schematic diagram illustrating initial operation when the handling robot attached the tool to the tool magazine. In the present example, a case in which the tool is attached to a tool holding unit A is shown.

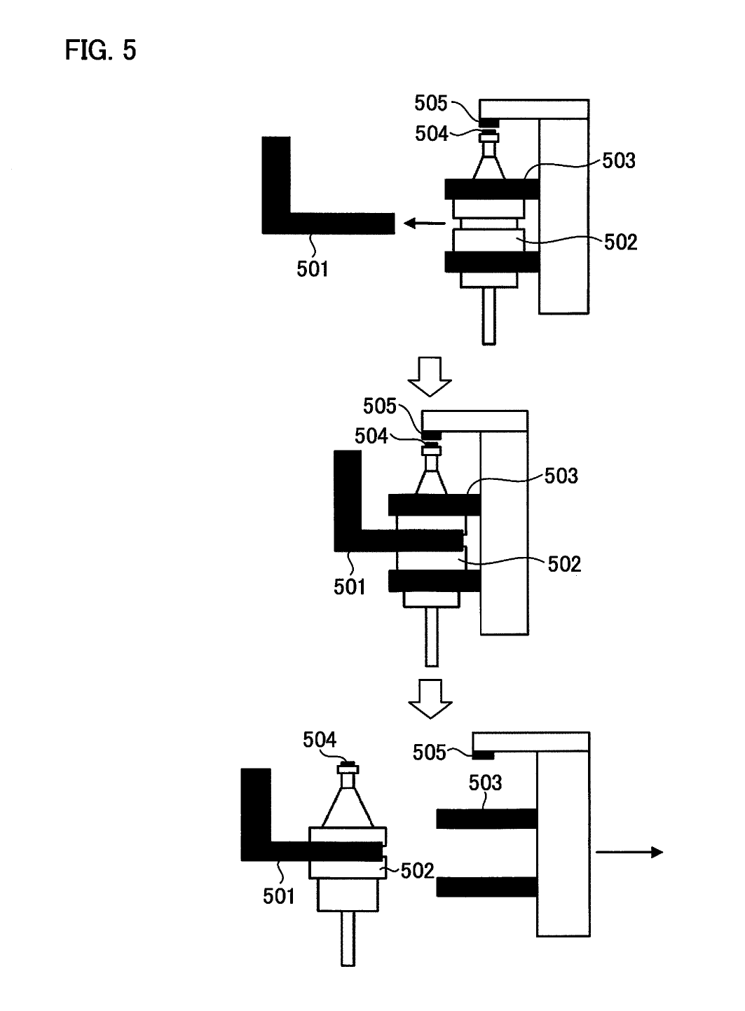

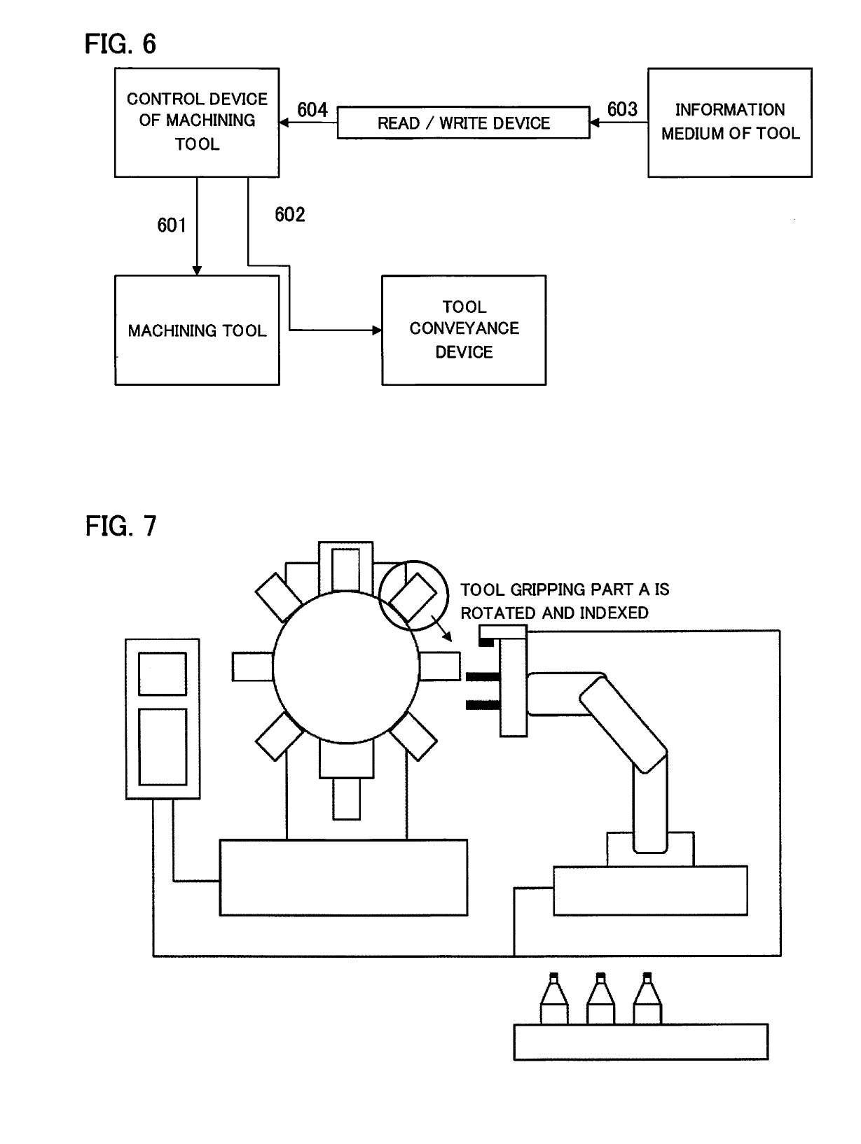

FIG. 5 is a schematic diagram illustrating sending and receiving operation of the tool between the tool holding unit A and the hand unit of the tool conveyance device. FIG. 6 is a block diagram illustrating control flow for the above operation.

The control device of the machining tool outputs command of indexing the tool holding unit A to the tool attachment and detachment position, to the machining tool (601). The control device also outputs command of conveying the tool X, to the tool conveyance device such as a handling robot (602).

The handling robot holds the designated tool X by the hand unit, and conveys the tool X to the tool magazine of the machining tool.

At this time, a magnetic head of the reading/writing device, such as an information reading and writing device attached to the handling robot, receives the tool information from the information medium of the tool X (603).

The received tool information of the tool X is sent to the control device of the machining tool (604), and the control device of the machining tool stores the tool information of the tool X received as the tool information at the tool holding unit A.

The handling robot leaves from the machining tool and waits for the next command, after attachment of the tool to the tool holding unit A is completed.

It should be noted that the tool information stored in the control device of the machining tool is updated at any time. For example, values of the tool usage frequency, the tool use time, and the like, are added by an amount the tool is used.

FIG. 7 is a schematic diagram illustrating initial operation when the handling robot detaches the tool from the tool magazine. In the present embodiment, an example in which the tool X is detached from the tool holding unit A is shown.

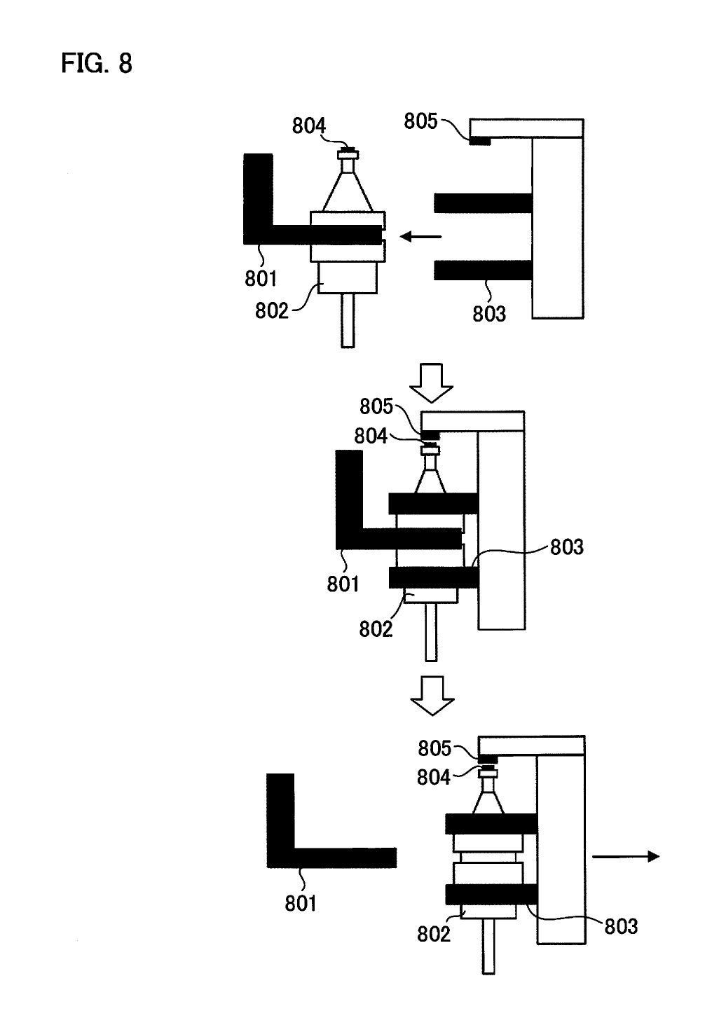

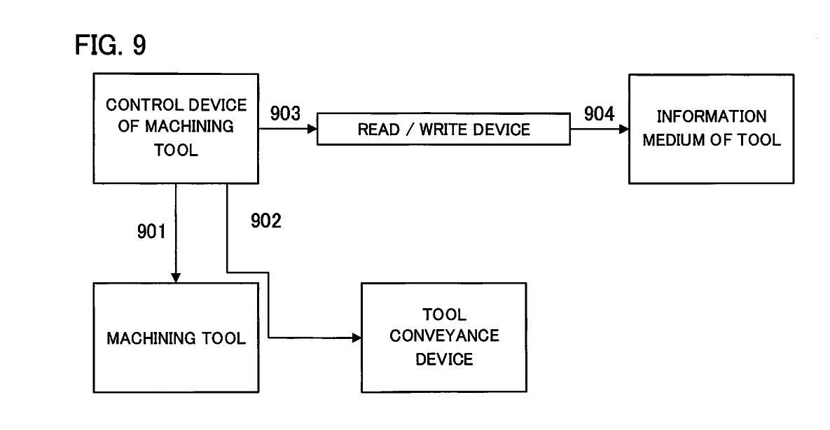

FIG. 8 is a schematic diagram illustrating sending and receiving operation of the tool between the tool holding unit A and the hand unit of the tool conveyance device. FIG. 9 is a block diagram illustrating control flow for the above operation.

The control device of the machining tool outputs command of indexing the tool holding unit A to the tool attachment and detachment position, to the machining tool (901). The control device also outputs command of detaching the tool at the tool holding unit A and conveying the tool X, to the tool conveyance device such as a handling robot (902).

The handling robot holds the tool X attached to the tool holding unit A which is indexed at the tool attachment and detachment position by the hand unit, detaches the tool X from the tool holding unit A, and conveys the tool X to the outside of the machining tool.

At this time, the control device of the machining tool sends the tool information at the tool holding unit A to the reading/writing device such as an information reading and writing device attached to the handling robot (903).

The information reading and writing device reads and writes the received tool information in the information medium of the tool X using the magnetic head (904).

The handling robot waits for the next command, after conveyance of the tool X is completed.

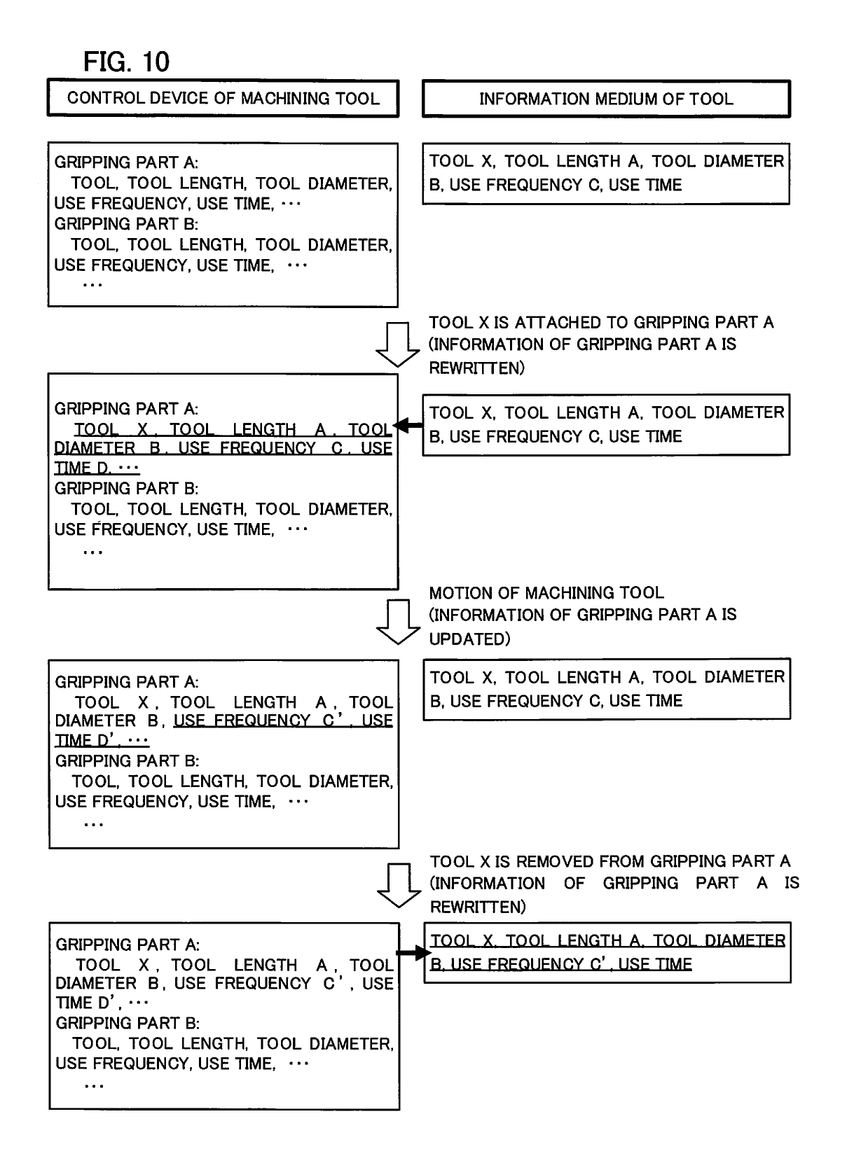

FIG. 10 is a block diagram illustrating sending and receiving of the tool information stored in the information medium of the tool X and the tool information of the tool holding unit A stored in the control device of the machining tool, when the tool X is attached or detached.

When the tool X is attached, the tool information stored in the information medium of the tool X is assigned to the tool information of the tool holding unit A stored in the control device of the machining tool.

The tool information of the tool holding unit A is updated during the operation of the machining tool.

When the tool X is detached, the tool information of the tool holding unit A stored in the control device of the machining tool is assigned to the tool information stored in the information medium of the tool X. Thus writing of the tool information updated by the operation of the machining tool in the information medium of the tool X is enabled.

With the above configuration and the above control method, it is possible to implement a machining system capable of machining without being restricted by the maximum number of the tool storable in the tool magazine of the machining tool, and automatic input and automatic updating of the tool information. In the present invention, the magnetic memory element is used as the information medium, however, the information medium may be any readable and writable information medium, such as an RFID.

In the present embodiment, an example using the tool in which the information medium is provided at the pull stud unit, however, the information medium may be provided at any part of the tool, such as key groove unit of the tool.

In the present invention, the handling robot needs to perform attachment and detachment of the tool separately, however the present invention can be applied to a case in which the tool conveyance device capable of simultaneous attachment and detachment of the tool, such as a handling robot equipped with a double arm is used.

When the tool conveyance device attaches and detaches the tool directly to the spindle of the machining tool, the present invention can be similarly applied as the case the tool is attached to and detached from the tool magazine.

In this case, automatic input and automatic updating of the tool information is similarly enabled by assigning the too information to the tool holding unit to which the tool attached to the spindle is stored after the tool is used.

In addition to that, in a case in which the tool lifetime (maximum hours of use) and the tool use time are recorded, comparing the tool lifetime and the tool use time and displaying of message or alarm when the tool use time exceeds the tool lifetime enables to prevent occurrence of damage of the tool or deterioration of machining precision.

Furthermore, when the tool use time exceeds the tool lifetime, the tool conveyance device may be configured to convey the tool to the outside of the machining system and supply a new tool from the outside of the machining system. Concerning the supply of the new tool, the tool conveyance device itself may supply the new tool, but the other device may supply the new tool. With the configuration, operation of the machining system with high efficiency is enabled, since there is no need for stopping operation of the machining system when the lifetime of the tool ends.

1. A machining system having a tool conveyance device comprising:
a machining tool equipped with a spindle and a tool magazine;
a tool conveyance device configured to mount and dismount the tool on the tool magazine;
a tool stand for placing the tool to be mounted on the tool magazine or dismounted from the tool magazine, wherein
the tool conveyance device includes at least one of an information read deice for reading tool information and an information write device for writing tool information in an information medium provided in the tool, and
the machining system having the tool conveyance device comprises a communication unit configured to send and receive the tool information among a control device of the machining tool, the tool conveyance device, and the information read device or the information write device.

2. A machining system having a tool conveyance device comprising:
a machining tool equipped with a spindle configured to be removably attached by a tool;
a tool conveyance device configured to mount and dismount the tool on the spindle;
a tool stand for placing the tool to be mounted on the spindle or dismounted from the spindle, wherein
the tool conveyance device includes at least one of an information read deice for reading tool information and an information write device for writing tool information in an information medium provided in the tool, and
the machining system having the tool conveyance device comprises a communication unit configured to send and receive the tool information among a control device of the machining tool, the tool conveyance device, and the information read device or the information write device.

3. A machining system having a tool conveyance device according to claim, wherein
tool information includes at least one of, tool number, tool length, tool length correction value, tool diameter, tool diameter correction value, tool weight, gravity center position of the tool, tool lifetime, tool use frequency, and tool use time.

4. A machining system having a tool conveyance device according to claim 3, wherein the machining tool comprises a display unit configured to display message or alarm when the tool use time exceeds the tool lifetime.

5. A machining system having a tool conveyance device according to claim 3, wherein the tool conveyance device comprises a unit for conveying the tool to outside of the machining system and convey and supply a tool other than the conveyed tool from the outside of the machining system to the tool stand when the tool use time exceeds the tool lifetime.
